(19) United States
(12) Patent Application Publication
(10) Pub. No.: US 2021/0313649 A1
(43) Pub. Date: Oct. 7, 2021

(54) BATTERY CELL HOLDER AND BATTERY SYSTEM

(71) Applicant: Robert Bosch GmbH, Stuttgart (DE)

(72) Inventors: Haris Alisic, Reutlingen (DE); Christian Zielke, Eningen Unter Achalm (DE)

(21) Appl. No.: 17/272,223

(22) PCT Filed: Oct. 29, 2019
(86) PCT No.: PCT/EP2019/079546

§ 371 Date: Feb. 26, 2021

(30) Foreign Application Priority Data
Nov. 30, 2018 (DE) 102018220687.2
Jul. 30, 2019 (DE) 102019211359.1

(51) Int. Cl. H01M 50/291; H01M 50/213; H01M 10/04; H01M 50/264; H01M 10/0525

(52) U.S. Cl. CPC H01M 50/291; H01M 50/213; H01M 10/0525; H01M 50/264; H01M 10/0481

(57) ABSTRACT

A battery cell holder. The battery cell holder includes: a housing made of an inelastic material, which is configured to receive a plurality of individual battery cells; an elastic intermediate unit having a plurality of passthrough openings, each passthrough opening being configured to receive one battery cell; and a preload device that is configured to exert a preload force on the elastic intermediate unit in such a way that the elastic intermediate unit becomes elastically deformed in order to clamp the battery cells.

### FIELD

The present invention relates to a battery cell holder and to a battery system having a plurality of battery cells.

### BACKGROUND INFORMATION

The present invention proceeds from cylindrical battery cells, in particular lithium ion cells, that preferably have numerous utilization capabilities as rechargeable electrochemical energy reservoirs. Usually, a plurality of battery cells is provided as an electrical grouping. Typical cylindrical lithium ion battery cells of this kind are standardized in terms of their dimensions, for example in the “18650” format (18 mm diameter, 65 mm height). The battery cells have relatively large dimensional tolerances, however, which can result in problems when disposing a plurality of battery cells in a housing. Lithium ion battery cells of this kind also experience changes in volume during a charging cycle and discharging cycle, which must be compensated for. In addition, such battery cells and battery systems are often subject to additional stresses due to vibration, oscillations, or entry and exit of gaseous or liquid media, which can result in damage to such battery systems. An increased need therefore exists for improved battery cell holders and battery systems.

### SUMMARY

A battery cell holder according to an example embodiment of the present invention may have the advantage that a tolerance compensation in several directions is possible even in a context of very large manufacturing-related tolerances, and the battery cell can thus be retained securely in the battery cell holder. This makes possible a considerable simplification in the processing of battery cells of different batches and/or from different manufacturers, which (as experience indicates) always have different tolerances. In addition, the battery cells held with the battery cell holder according to the present invention can be protected in controlled fashion with respect to vibrations, oscillations, impacts, and the like. In particular, reliable vibration decoupling can be implemented. Additional thermal, contact-based coupling of the individual battery cells can furthermore be enabled, resulting in considerably better heat dissipation from individual battery cells over long periods of time. This is achieved according to an example embodiment of the present invention by the fact that the battery cell holder has a housing made of an inelastic material, in particular a hard plastic. The housing is configured to receive and retain a plurality of individual battery cells. The battery cell holder furthermore encompasses an elastic intermediate unit. Also provided is a preload device that is configured to exert a preload force on the elastic intermediate unit in such a way that the elastic intermediate unit becomes deformed and the battery cell becomes clamped by way of the deformed elastic intermediate unit. Before exertion of the preload force there thus exists, between the elastic intermediate unit and the inserted individual battery cells, a respective interstice that then disappears after application of the preload force of the preload device. The individual battery cells are thus, as a result of the elastic intermediate unit, in contact therewith after application of the preload force, and are securely retained.

Preferred refinements of the present invention are disclosed herein.

The elastic intermediate unit preferably encompasses an elastic, one-piece insert, similar to a perforated panel, having a plurality of passthrough openings. Such inserts can be manufactured easily and inexpensively in large quantities from elastic material.

Also preferably, the battery cell holder in accordance with an example embodiment of the present invention encompasses a multi-part housing, in particular a two-part housing; the preload device being configured in such a way as to exert a preload force on the housing so that the elastic intermediate unit becomes elastically deformed in order to clamp the batteries. The preload force can thus be transferred from outside the housing onto the housing, and via the housing onto the elastic intermediate unit. The preload device thus does not need to be disposed in the interior of the housing, so that the battery cells can be disposed very compactly.

Also preferably, the preload device is adjustable. It is thereby possible to vary a preload force so that, in particular, different dimensional discrepancies of the battery cells can be reacted to. The adjustable preload device can be implemented, for example, by way of a screw connection or an adjustable spring element or the like.

Alternatively, the preload device is configured in such a way that the preload device applies only a predetermined preload force. This approach is particularly inexpensive but can cause the respective preload forces on the battery cells to be different in a context of differing tolerances for different individual battery cells. This is acceptable, however, and does not result in disadvantages in terms of the use of the battery cells. A preload device of this kind can be implemented, for example, by way of a welded connection between, for instance, the cover and a base of the housing, or by way of clip elements or the like that hold the cover on the base.

Also preferably, according to an alternative embodiment the battery cell holder has a preload device having a plurality of pin elements. The elastic intermediate unit has a plurality of auxiliary holes at transition regions between the passthrough openings in order to receive the battery cells. Each pin element is respectively disposed in an auxiliary hole. The pin elements have a diameter that at least in part is greater than a diameter of the auxiliary holes. The result is to expand the auxiliary holes so that the elastic deformation of the elastic intermediate unit occurs. The battery cells are thereby clamped. The pin elements are equipped, for example, with a conical end and with a cylindrical part having a larger diameter than the diameter of the auxiliary holes, or alternatively are embodied entirely with a conical or otherwise tapering main body. The pin elements preferably have a head, thereby simplifying insertion into and removal from the auxiliary holes.

The battery cell holder is preferably constructed in such a way that the multi-part housing comes into contact with the pin elements upon assembly, and the housing is configured to push the pin elements into the auxiliary holes.

Projecting regions can preferably be provided on the housing in the region of the pin elements.

Also preferably, the elastic intermediate unit encompasses at least a first elastic element and a second elastic element. The two elastic elements are disposed in the battery cell holder with a spacing from one another in an axial direction of the passthrough openings. As a result, the inserted batteries are securely retained by the elastic intermediate unit at two points, namely by the first and the second elastic element.

For cost reduction, the first and the second elastic element are preferably of identical construction.

Also preferably, the battery cell holder encompasses a bracing element made of an inelastic material, which is disposed adjacently to the elastic intermediate unit. The bracing element is preferably disposed between the first and the second elastic element in an axial direction of the passthrough openings. The bracing element serves as a support when the preload device exerts a preload force on the multi-part housing and the first and the second elastic element become elastically deformed.

The bracing element preferably encompasses a plurality of individual sleeves that are oriented in the first and the second elastic element to correspond to the passthrough openings. Alternatively, the bracing element encompasses a one-piece element, similar to a perforated panel, having a plurality of passthrough openings that are oriented in accordance with the passthrough elements in the first and the second elastic element.

The housing preferably has a base and a cover. Openings for electrical contacting of the individual battery cells are preferably provided in the base and/or in the cover. The base is preferably cup-shaped.

The elastic intermediate unit preferably encompasses a plurality of passthrough openings, each passthrough opening being configured for reception of a battery cell. The battery cells are thereby surrounded by the elastic intermediate unit. Each passthrough opening is configured for reception of a single battery cell. Before the preload force is exerted there exists, between the passthrough openings of the elastic intermediate unit and the inserted individual battery cells, a respective annular interstice that disappears after the preload force is exerted.

According to a further preferred example embodiment of the present invention, the elastic intermediate unit has a plurality of elastic individual elements. As a result, the weight of the elastic intermediate unit can be significantly reduced and an installation space required for the elastic intermediate unit can be minimized.

Alternatively, the elastic intermediate unit encompasses exactly one single individual part having a plurality of clamping regions. The clamping regions are configured to clamp the plurality of battery cells. The operation of clamping the battery cells preferably takes place between the housing and the clamping regions. A plurality of connecting regions connects the clamping regions to one another.

According to a further preferred example embodiment of the present invention, the battery cell holder further encompasses a bracing element. The elastic intermediate unit is disposed on the bracing element. The bracing element serves to support the elastic intermediate unit. If a plurality of elastic individual elements are provided, the bracing element also serves to support the individual elastic individual elements.

The elastic intermediate unit is preferably immobilized on the bracing element. This is preferably accomplished by adhesive bonding or welding or the like. Also preferably, the elastic intermediate unit and the bracing element constitute a two-constituent component made up of an inelastic carrier element with an elastic intermediate component overmolded onto the carrier element. In particular, individual elastic individual elements, or a single individual part, can be overmolded onto the inelastic carrier element.

According to a further preferred example embodiment of the present invention, the elastic intermediate unit has auxiliary holes. Alternatively, the elastic intermediate unit has no holes or the like.

Also preferably, the bracing element has a plurality of passthrough openings, each passthrough opening being configured to receive one battery cell. As a result, the battery cells can be prepositioned in the passthrough openings of the bracing element in the context of assembly.

Also preferably, the battery cell holder encompasses at least one electrical contacting element that is disposed on the elastic intermediate unit and is configured to electrically contact a battery cell on its enveloping surface. Preferably, a plurality of electrical contacting elements are provided. The electrical contacting element is a voltage-carrying element, for example a cable, FPC, or a sub-region of a circuit board. Upon expansion of the elastic intermediate element, the electrical contacting element also becomes pressed against the cell body of the battery cell, and the latter can thereby be permanently contacted if the battery cell does not have an insulating enveloping surface or if it has an opening or the like in the insulating enveloping surface. Individual battery cells can thereby be contacted, or electrical contacting to parallel-connected battery-cell groupings having the same potential can be enabled, so that an entire battery system can be monitored.

The present invention furthermore relates to a battery system encompassing a plurality of battery cells and a battery cell holder according to the present invention.

The battery system in accordance with an example embodiment of the present invention preferably encompasses a cooling device that delivers a cooling medium into the housing. It is particularly preferred if the elastic intermediate unit encompasses the first and the second elastic element, so that cooling medium can flow into an interstice formed at the battery cells by the first and the second elastic element, and can cool the battery cells. In particular if the cooling medium is a liquid medium and not air, a sealed cooling space can be furnished at the battery cells by the first and the second elastic element of the elastic intermediate unit, thereby enabling reliable sealing.

The simple and weight-optimized construction of the battery system makes the battery system according to the present invention particularly suitable for electric bicycles.

### BRIEF DESCRIPTION OF THE DRAWINGS

Preferred exemplifying embodiments of the present invention are described in detail below with reference to the figures,

FIG. 1 is a schematic cross-sectional view of a battery system having a battery cell holder in accordance with a first exemplifying embodiment of the present invention, in the installed state.

FIG. 2 is a schematic cross-sectional view of the battery system of FIG. 1 in the non-installed state, in accordance with an example embodiment of the present invention.

FIG. 3 is a schematic longitudinal section view along line III-III of FIG. 2.

FIG. 4 is a schematic longitudinal section view along line IV-IV of FIG. 1.

FIG. 5 is a schematic cross-sectional view of a battery system having a battery cell holder in accordance with a second preferred exemplifying embodiment of the present invention, in the installed state.

FIGS. 6 to 8 are schematic section views of a battery cell holder in accordance with a third exemplifying embodiment of the present invention.

FIGS. 9 and 10 are schematic views of a battery cell holder in accordance with a fourth exemplifying embodiment of the present invention.

FIG. 11 is a schematic view of a battery cell holder in accordance with a fifth exemplifying embodiment of the present invention.

FIG. 12 is a schematic view of a battery cell holder in accordance with a sixth exemplifying embodiment of the present invention.

FIG. 13 is a schematic view of a battery cell holder in accordance with a seventh exemplifying embodiment of the present invention.

### DETAILED DESCRIPTION OF EXAMPLE EMBODIMENTS

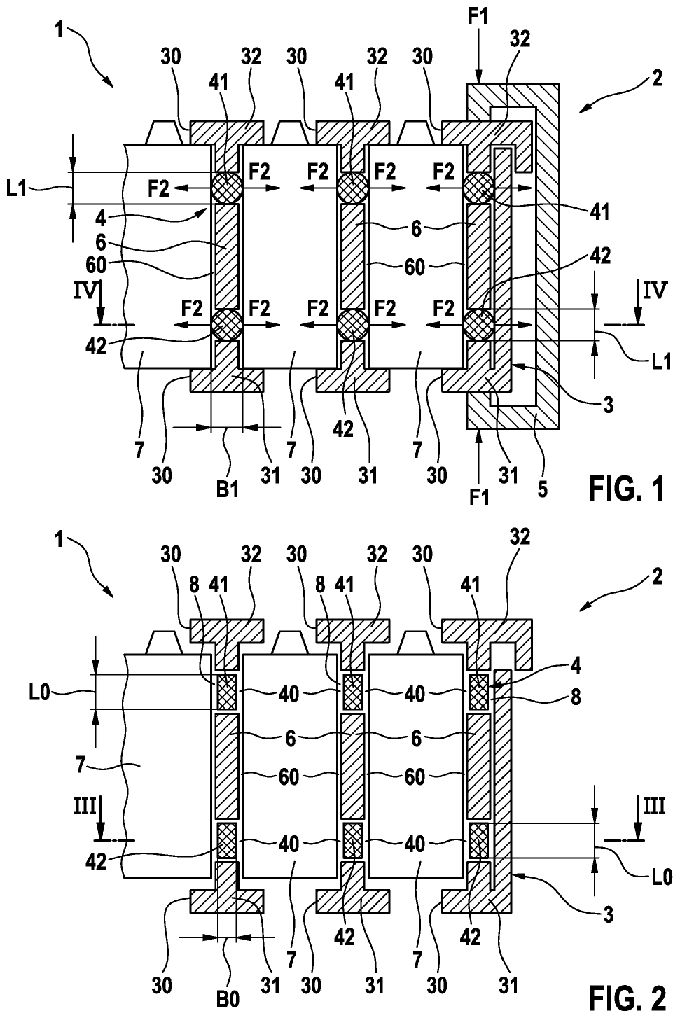

A battery system 1 having a battery cell holder 2 will be described in detail below with reference to FIGS. 1 to 4.

In the installed state, as is evident from FIG. 1, battery cell holder 2 encompasses a multi-part housing 3 having a base 31 and a cover 32. A plurality of openings 30 for electrical contacting of battery cells 7 are provided respectively in base 31 and in cover 32.

Battery cells 7 are cylindrical battery cells and can be, for example, lithium ion cells.

Battery cell holder 2 further encompasses an elastic intermediate unit 4 as well as a preload device 5. Elastic intermediate unit 4 of this exemplifying embodiment encompasses a first elastic element 41 and a second elastic element 42. A plurality of passthrough openings 40 are provided respectively in first elastic element 41 and in second elastic element 42. As is evident from FIG. 1, the individual battery cells 7 are introduced through passthrough openings 40 of elastic intermediate unit 4. Passthrough openings 40 thus serve to receive battery cells 7.

In this example, preload device 5 is a clip-like clamp that exerts a preload force F1 on housing 3. As depicted schematically in FIG. 1, the clamp fits around base 31 and cover 32 in order to exert preload force F1 respectively both on the base and on the cover. Preload force F1 is transferred via base 31 and cover 32 onto first and second elastic elements 41, 42 of elastic intermediate element 4.

As is evident from FIG. 1, battery cell holder 2 of this exemplifying embodiment furthermore also encompasses a bracing element 6. Bracing element 6 is disposed between first and second elastic elements 41, 42 in an axial direction of the passthrough openings. Bracing element 6 is manufactured from an inelastic material. In this exemplifying embodiment, bracing element 6 is a one-piece component that likewise has passthrough openings 60 for the reception of battery cells 7.

FIG. 2 shows the state of battery cell holder 2 with no preload force, elastic elements 41, 42 of elastic intermediate unit 4 not being elastically deformed. As is evident from FIG. 2, first and second elastic elements 41, 42 and inelastic bracing element 6 are in principle of similar geometrical construction; in the unloaded state, passthrough openings 40 of elastic elements 41, 42 are larger than passthrough openings 60 of bracing element 6.

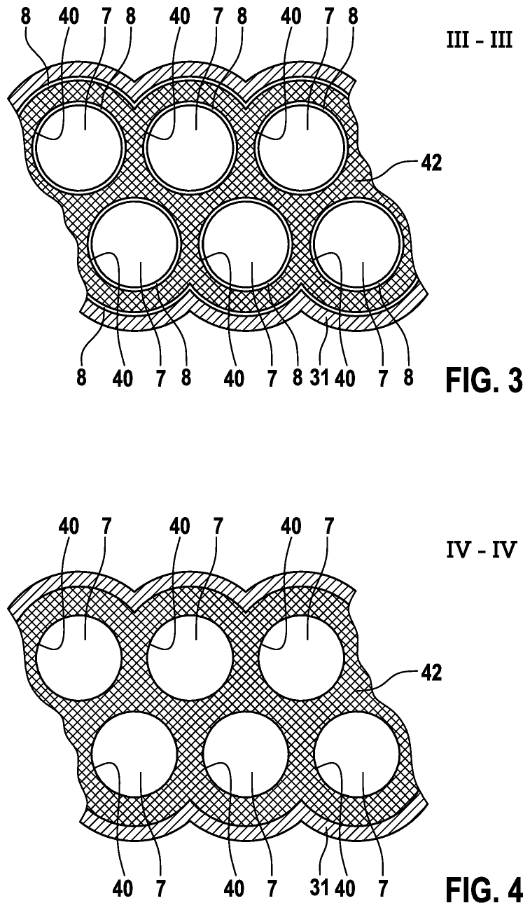

As already explained above, preload device 5 causes preload force F1 to be transferred to housing 3. Because housing 3 is manufactured from an inelastic material, this preload force F1 becomes transferred to first and second elastic elements 41, 42 of elastic intermediate element 4. Bracing element 6 serves here as a support. This results simultaneously in an elastic deformation of first and second elastic elements 41, 42, as indicated in FIG. 1 by arrows F2. The result is that a gap 8 (see FIGS. 2 and 3), which is present at elastic elements 41, 42 when battery cell holder 2 is in the unpreloaded state, becomes eliminated, and first and second elastic elements 41, 42 exert a holding force directed onto battery cells 7.

Even large manufacturing-related tolerances of battery cells 7, in particular in terms of their circumference and/or length, can thereby be compensated for. As a comparison between FIGS. 1 and 2 shows, an initial length LO of first and second elastic elements 41, 42 is decreased, by the exertion of preload force F1, to a reduced length Ll. An initial width B0 (FIG. 2) in the unpreloaded state is furthermore increased in the preloaded state to a larger width B1 (see FIG. 1).

Because of the elastic deformation of the first and the second elastic element, first and second elastic elements 41, 42 thus also abut sealingly against battery cells 7 (see FIGS. 1 and 4). A full-coverage, frictionally engaged connection between battery cell holder 2 and the individual battery cells 7 can thus be achieved. Secure and robust retention of the individual battery cells can thereby be enabled. In addition to the holding function, the retention by way of first and second elastic elements 41, 42 additionally produces improved damping of external influencing forces, for example oscillations and/or vibrations and/or impacts or the like. In particular, the individual battery cells 7 are not in direct contact with the multi-part housing 3, so that no direct transfer of such external influences to the individual battery cells 2 occurs.

In addition, improved thermal heat dissipation compared with the related art can be achieved, since a thermal conductivity of the elastic intermediate unit 4, if the latter is manufactured, e.g., from a polymer, is considerably better (A polymer approx. 0.2 W/mK) than, for example, a thermal conductivity of air (A air approx. 0.0024 W/mK).

The use of elastic intermediate unit 4 furthermore makes possible improved partitioning of the individual battery cells from one another and also with respect to the environment, for instance if hot gases and/or liquids emerge from the individual battery cells 7 in the event of a fault. The safety of battery system 1 can thus additionally be improved.

For illustration, FIG. 3 is a longitudinal section along line III-III of FIG. 2, the annular gap 8 at each individual battery cell 7 with respect to second elastic element 42 being illustrated. This gap 8 is of course, present in the unloaded, i.e., unpreloaded, state in the same way as with first elastic element 41. FIG. 4 is a longitudinal section along line IV-IV of FIG. 1, and thus shows by way of example the preloaded state at second elastic element 42, in which first and second elastic elements 41, 42 are elastically deformed and thus abut tightly and sealingly against the individual battery cells 7. The respective gap 8 that is still present in the unpreloaded state completely disappears as a result.

As is further evident from FIGS. 3 and 4, the individual battery cells 7 are disposed in two rows with an offset from one another, thereby achieving a particularly compact and space-saving configuration.

Secure holding of the individual battery cells 7, and decoupling from external influences, is furthermore achieved by way of the dual retention via first and second elastic elements 41, 42.

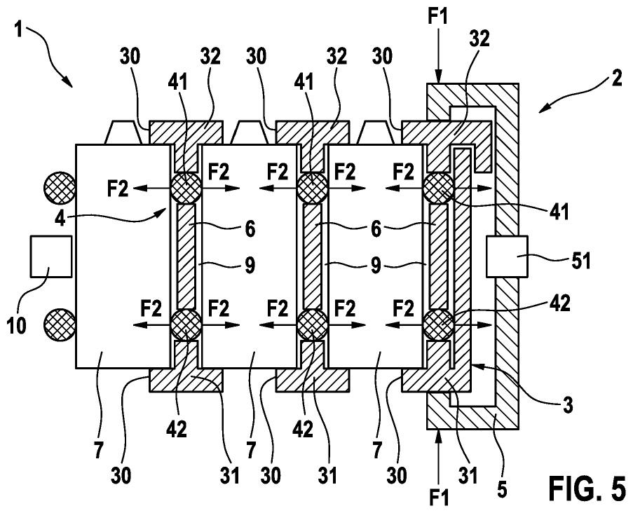

FIG. 5 shows a battery system 1 in accordance with a second exemplifying embodiment of the invention, identical or functionally identical parts being labeled respectively with the same reference characters. In contrast to the first exemplifying embodiment, the exemplifying embodiment of FIG. 5 has an adjustable preload device 5 in which an adjusting element 51, for example a screw connection, with which a preload force F1 on housing 3 can be modified, is present. Further in contrast to the first exemplifying embodiment, in the second exemplifying embodiment a diameter of passthrough openings 60 of bracing element 6 is selected in such a way that an interstice 9 remains between bracing element 6 and the individual battery cells 7 even in the finally installed state upon application of the preload force onto housing 3. As a result of the sealing of first and second elastic elements 41, 42 of elastic intermediate unit 4, this interstice 9 can be used, for example, for cooling by way of a cooling device 10 that, for example, allows a liquid or gaseous cooling medium to flow through interstices 9.

This exemplifying embodiment otherwise corresponds to the preceding exemplifying embodiment, so that reference may be made to the description provided there.

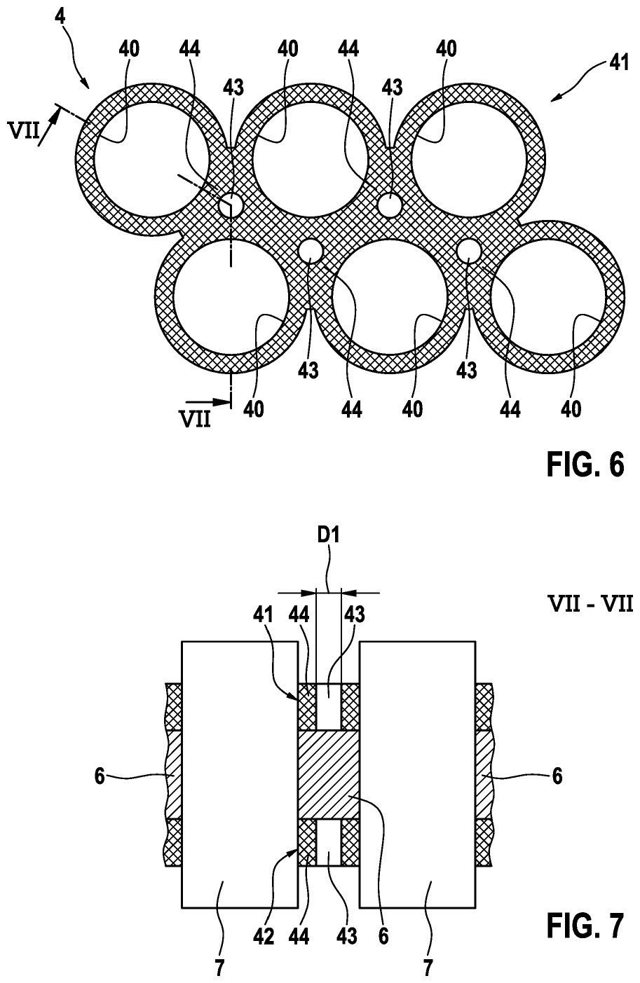

FIGS. 6 to 8 are schematic section views of a battery cell holder 1 in accordance with a third exemplifying embodiment of the invention.

As is evident from the section view of FIG. 6, and from FIG. 7, which is a section along line VII-VII of FIG. 6, the battery cell holder encompasses an elastic intermediate unit 4 having a first elastic element 41 and a second elastic element 42. First and second elastic elements 41, 42 are of identical construction. In contrast to the above-described exemplifying embodiments, a plurality of auxiliary holes 43 are additionally provided in first and second elastic elements 41 and 42. As is evident from FIG. 6, auxiliary holes 43 are provided in intermediate regions 44 between passthrough openings 40 in the material of the elastic elements. As is evident from FIG. 6, four auxiliary holes 43 are embodied in first elastic element 41.

As is further evident from FIG. 7, a bracing element 6 is disposed between first and second elastic elements 41, 42. As in the above-described exemplifying embodiments, bracing element 6 serves as a support when a preload force is exerted on first and second elastic elements 41, 42.

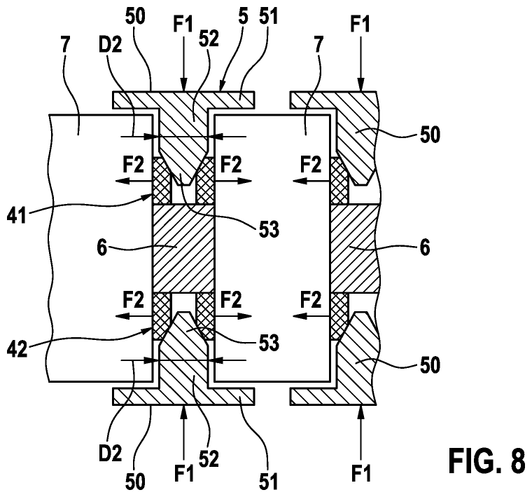

Preload device 5 of the third exemplifying embodiment encompasses pin elements 50 that are visible in detail in FIG. 8. Pin elements 50 encompass a head 51, a main body 52, and a conical region 53 at that end of the pin element which is located oppositely from the head. A diameter D1 of auxiliary holes 43 in the undeformed state (see FIG. 7) is smaller than a diameter D2 of main body 52 of pin elements 50. Thanks to conical region 53, pin elements 50 can easily be introduced and pressed into auxiliary holes 43, with the result that an elastic deformation of first and second elastic elements 41, 42 occurs. First and second elastic elements 41, 42 become elastically deformed by the pressing in of pin elements 50 with preload force F1, as indicated in FIG. 8 by arrows F2. A clamping of battery cells 7 by the elastically deformed intermediate unit 4 occurs as a result.

Be it noted that preload force F1 can be applied in different ways onto pin elements 50. Separate additional preload devices can be provided for that purpose, for example, or projections or springs or the like can be disposed on a housing (not shown in FIGS. 6 to 8) and exert the preload force onto pin elements 50, inserted loosely into auxiliary holes 43, upon assembly of the housing, so that when the housing is put together, pin elements 50 are also simultaneously pressed into auxiliary holes 43 and battery cells 7 are clamped.

This exemplifying embodiment otherwise corresponds to the preceding exemplifying embodiment, so that reference may be made to the description provided there.

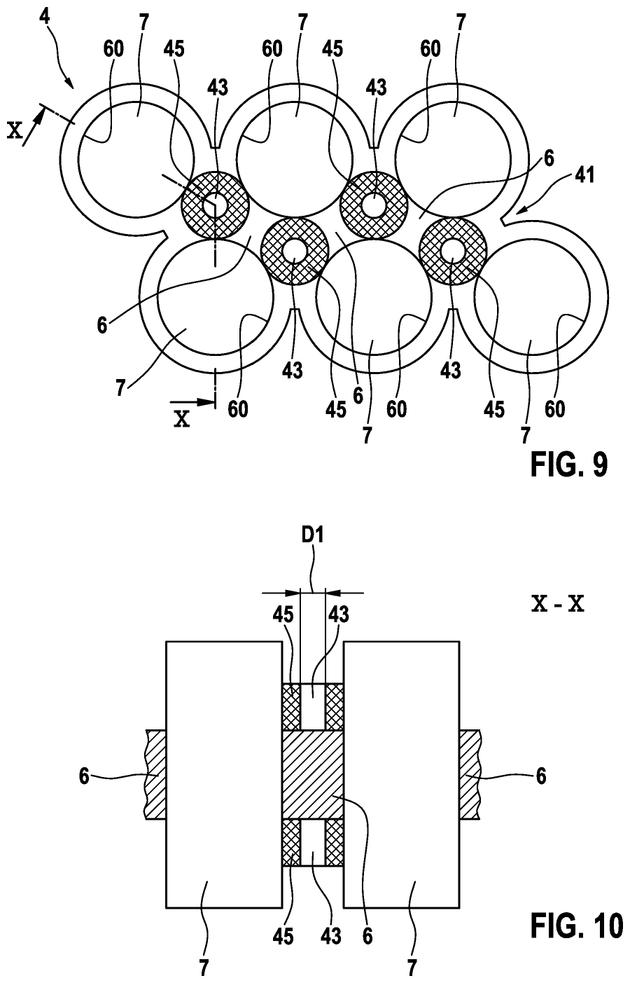

FIGS. 9 and 10 show a battery cell holder in accordance with a fourth exemplifying embodiment of the present invention. In contrast to the preceding exemplifying embodiments, the battery cell holder of the fourth exemplifying embodiment encompasses a plurality of elastic individual elements 45. As is evident from FIG. 9, the elastic individual elements are disposed in intermediate regions between battery cells 7. Each elastic individual element 45 contacts three battery cells. Each elastic individual element 45 furthermore has an auxiliary hole 43 into which, as described in conjunction with the third exemplifying embodiment, a pin element or the like can be inserted in order to produce an elastic expansion of the individual elastic individual elements 45. As is evident from FIGS. 9 and 10, an inelastic bracing element 6 (carrier element), which has recesses 60 in which the individual battery cells 7 are disposed, is also provided. The individual elastic individual elements 45 are immobilized on the inelastic bracing element 6. As shown in FIG. 10, elastic individual elements 45 are disposed on an upper side and a lower side of bracing element 6. This is achieved preferably by overmolding individual elements 45 onto bracing element 6. Alternatively, individual elements 45 can also be immobilized on bracing element 6 by adhesive bonding or welding or the like.

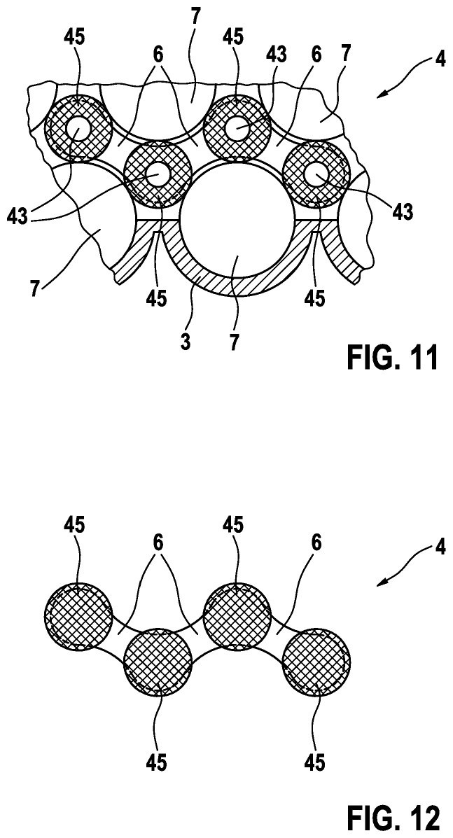

FIG. 11 shows a battery cell holder in accordance with a fifth exemplifying embodiment of the invention. The fifth exemplifying embodiment corresponds substantially to the fourth exemplifying embodiment, bracing element 6 being, in contrast thereto, embodied differently. As is evident from FIG. 11, bracing element 6 is S-shaped and is provided only in the inner intermediate region between battery cells 7. As in the fourth exemplifying embodiment, bracing element 6 carries a plurality of individual elastic individual elements 45 that each have a recess 43. Battery cells 7 then become clamped between individual elements 45 and housing 3. A weight of the battery cell holder can thereby be further reduced. As in the above-described exemplifying embodiments, elastic individual elements 45 can be provided above and below bracing element 6.

FIG. 12 shows a sixth exemplifying embodiment of the invention, which corresponds substantially to the fifth exemplifying embodiment. In contrast thereto, the sixth exemplifying embodiment has elastic individual elements 45 having no auxiliary openings. In other words, an elastic deformation of elastic individual elements 45 is effected only by exertion of a preload force onto the exposed upper surface. As in FIG. 11, bracing element 6 is S-shaped.

Be it noted, alternatively to the exemplifying embodiment of FIG. 12, that elastic intermediate unit 4 can also be injection-molded as a two-constituent component, only connecting bridges made of non-elastic material being provided between the elastic individual elements 45.

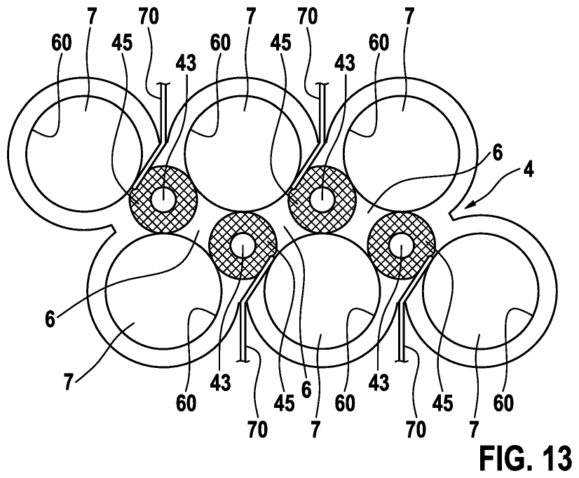

FIG. 13 shows a seventh exemplifying embodiment of the invention which corresponds substantially to the fourth exemplifying embodiment of FIGS. 9 and 10. In the seventh exemplifying embodiment, electrical contacting elements 70 are additionally provided, while elastic intermediate unit 4 corresponds to that of FIG. 9. Electrical contacting elements 70 are each disposed on elastic intermediate unit 4. More precisely, electrical contacting elements 70 are disposed on elastic individual elements 45 of elastic intermediate unit 4. FIG. 13 shows the installed state, so that a deformation of elastic individual elements 45 has taken place. This deformation causes electrical contacting elements 70 to be pressed against the enveloping surface of battery cells 7. Battery cells 7 have no insulating material on the regions at which they are contacted by electrical contacting elements 70. Permanent electrical contacting of battery cells 7 by electrical contacting elements 70 can thereby be enabled. Depending on how the battery cells are interconnected, individual battery cells can be contacted or, in a context of battery cell groupings connected in parallel, all battery cells can also be electrically contacted.

Easy voltage monitoring of battery cells 7 can thus be performed, for example. Electrical contacting elements 70 are preferably cables, or parts of a circuit board, or metallic tabs, or the like.

1-24. (canceled)

25. A battery cell holder, comprising:
a housing, made of an inelastic material, which is configured to receive a plurality of individual battery cells;
an elastic intermediate unit; and
a preload device that is configured to exert a preload force on the elastic intermediate unit in such a way that the elastic intermediate unit becomes elastically deformed to clamp the battery cells.

26. The battery cell holder as recited in claim 25, wherein the intermediate unit has a plurality of passthrough openings, each of the passthrough openings being configured to receive one of the battery cells.

27. The battery cell holder as recited in claim 26, wherein the elastic intermediate unit is an elastic, one-piece insert, similar to a perforated panel having a plurality of passthrough openings.

28. The battery cell holder as recited in claim 25, wherein the housing is in multiple parts, and wherein the preload device is configured so as to exert the preload force on the housing so that the elastic intermediate unit becomes elastically deformed to clamp the battery cells.

29. The battery cell holder as recited in claim 25, wherein the preload device is configured to furnish an adjustable preload force by way of a screw connection.

30. The battery cell holder as recited in claim 25, the preload device applying only a predetermined preload force and has a welded connection and/or a clip connection.

31. The battery cell holder as recited in claim 26, wherein the preload device has a plurality of pin elements, the elastic intermediate unit has a plurality of auxiliary holes at transition regions between the passthrough openings, each of the pin elements is respectively disposed in an auxiliary hole of the auxiliary holes, and a diameter of the pin elements is at least in part greater than a diameter of the auxiliary holes.

32. The battery cell holder as recited in claim 31, wherein the housing coming into contact with the pin elements upon assembly, and the housing is configured to push the pin elements into the auxiliary holes.

33. The battery cell holder as recited in claim 31, wherein each of the pin elements has at a free end a conically tapering region.

34. The battery cell holder as recited in claim 26, wherein the elastic intermediate unit includes a first elastic element and a second elastic element that are disposed with a spacing from one another in an axial direction of the battery cells.

35. The battery cell holder as recited in claim 34, further comprising:
a bracing element disposed adjacently to the elastic intermediate unit.

36. The battery cell holder as recited in claim 35, wherein the bracing element is disposed between the first elastic element and the second elastic element in an axial direction of the passthrough openings.

37. The battery cell holder as recited in claim 35, wherein the bracing includes a plurality of individual sleeves, or the bracing element is a one-piece element, similar to a perforated panel having a plurality of passthrough openings.

38. The battery cell holder as recited in claim 25, wherein the housing has a base and a cover.

39. The battery cell holder as recited in claim 25, wherein the elastic intermediate unit includes a plurality of elastic individual elements.

40. The battery cell holder as recited in claim 25, wherein the elastic intermediate unit includes a single elastic individual part having a plurality of clamping regions.

41. The battery cell holder as recited in claim 39, further comprising:
a bracing element, the elastic intermediate unit being disposed on an upper side and a lower side of the bracing element.

42. The battery cell holder as recited in claim 41, wherein the elastic intermediate unit is immobilized on the bracing element.

43. The battery cell holder as recited in claim 42, wherein the elastic intermediate unit and the bracing element constituting a two-constituent component made up of an inelastic carrier element and an elastic intermediate component overmolded onto the carrier element.

44. The battery cell holder as recited in claim 39, wherein the elastic intermediate unit auxiliary holes or is without any openings.

45. The battery cell holder as recited in claim 42, wherein the bracing element has a plurality of passthrough openings, each of the passthrough openings being configured to receive one of the battery cells.

46. The battery cell holder as recited in claim 25, further comprising:
an electrical contacting element disposed on the elastic intermediate unit and configured to electrically contact an enveloping surface of a battery cell of the battery cells.

47. A battery system, comprising:
a plurality of battery cells; and
a battery cell holder including:
a housing, made of an inelastic material, which is configured to receive the plurality of battery cells,
an elastic intermediate unit, and
a preload device that is configured to exert a preload force on the elastic intermediate unit in such a way that the elastic intermediate unit becomes elastically deformed to clamp the battery cells.

48. The battery system as recited in claim 47, further encompassing:
a cooling device configured to deliver a cooling medium into an interstice between the battery cells and the elastic intermediate unit.
